(19) United States
(12) Patent Application Publication
(10) Pub. No.: US 2008/0294700 A1
(43) Pub. Date: Nov. 27, 2008

(54) FILE MANAGEMENT SYSTEM, FILE MANAGEMENT METHOD, FILE MANAGEMENT PROGRAM

(75) Inventor: Kinichi SUGIMOTO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/125,983

(22) Filed: May 23, 2008

(30) Foreign Application Priority Data
May 23, 2007 (JP) 2007-137220

(51) Int. Cl. G06F 17/30

(52) U.S. Cl. 707/200; 707/E17.01

(57) ABSTRACT

A file management system and the like for alleviating the load on the hardware due to file synchronization are provided. A file management system includes a time measurement unit for recording an update history of the file; an update interval calculation unit for calculating an update interval and a blank period of the file based on the update history, and determining a synchronization time of the file based on the update interval and the blank period; and a file management unit for executing synchronization of the file stored in the plurality of storage media at the synchronization time.

### CROSS-REFERENCE TO RELATED APPLICATION

This application is based upon and claims the benefit of priority from Japanese patent application No. 2007-137220, filed on May 23, 2007, the disclosure of which is incorporated herein in its entirety by reference.

### BACKGROUND OF THE INVENTION

1. Field of the Invention

The present invention relates to file management systems of files stored in an external storage device such as a magnetic disc, in particular, to a synchronous management system of the files stored in a plurality of external storage devices.

2. Description of the Related Art

When clients of a personal computer and the like share files through a network, a file management system for managing a disc space mounted on a file server of the network performs file management. In this case, the data is generally taken backup by periodically making copies using the external storage device existing on the same network in order to prevent loss of data on the external storage device and to prevent accesses from concentrating on a specific external storage device. Specifically, the access load on the same file is distributed to a plurality of external storage devices and the load is reduced by making copies so that the same data is held in a plurality of external storage devices. The risk of losing important data is reduced by copying the data on an exchange medium such as tape, and storing the exchange medium in a safe place.

Japanese Laid-Open Patent Publication No. 2003-196136 (Patent document 1) discloses a backup system for realizing a backup operation in units of files or realizing difference backup of backing up only the updated files by using an external storage device mounted with the file management system for the backup of a network connected storage mounted with the file management system.

Japanese Laid-Open Patent Publication No. 2001-159997 (Patent document 2) discloses a method of suppressing the server access frequency, and reducing the file access or the load of the network by holding update interval information of page data in a file management system that performs file input/output with an HTTP (Hyper Text Transfer Protocol of web server and the like.

Japanese Laid-Open Patent Publication No. 2004-005092 (Patent document 3) discloses a storage system including a synchronization level management table for registering/managing synchronization levels for every information type, and a synchronization interval registration table for registering/managing synchronization time interval of the information on the synchronization level.

The related arts have the following problems.

In the file management system, generation date and time, update date and time, owner, and other attributes of a logical collection called a file which is managed by the file management system are to be managed, but update frequency, usage mode, time fluctuation of the update frequency of the data are not to be managed. Thus, in order to synchronize the file which is constantly reflecting the recent state, that is, in order to take backup for example, there is a need to frequently perform the backup operation itself, to constantly monitor the update state of the file, and the like. As a result, the load on the hardware of the external storage device etc. and on the network becomes large.

### SUMMARY OF THE INVENTION

It is an exemplary object of the invention to provide a file management system etc. for reducing the load on the hardware due to file synchronization.

A file management system according to an exemplary aspect of the invention includes a time measurement unit for recording an update history of a file; an update interval calculation unit for calculating an update interval and a blank period of the file based on the update history and determining a synchronization time of the file based on the update interval and the blank period; and a file management unit for executing synchronization of the file stored in a plurality of storage media at the synchronization time.

### BRIEF DESCRIPTION OF THE DRAWINGS

FIG. 1 is a configuration view showing a first exemplary embodiment of the invention;

FIG. 2 is a configuration view showing a master server of the first exemplary embodiment of the invention;

FIG. 3 is a configuration view showing a slave server of the first exemplary embodiment of the invention;

FIG. 4 is an example of metadata of a file management system;

FIG. 5 is an example of history management metadata of the file management system;

FIG. 6 is an example of update interval management metadata of the file management system;

FIG. 7 is a flowchart of a synchronous management algorithm of the master server of the first exemplary embodiment of the invention;

FIG. 8 is a flowchart of a synchronous management algorithm of the slave server of the first exemplary embodiment of the invention;

FIG. 9 is an explanatory view of an access history to a file;

FIG. 10 is an explanatory view of the access history to the file;

FIG. 11 is an explanatory view of an update directory;

FIG. 12 is a flowchart of a synchronous management algorithm of a master server according to the second exemplary embodiment;

FIG. 13 is a flowchart of a synchronous management algorithm of a slave server according to the second exemplary embodiment;

FIG. 14 is a configuration view of a PC according to a third exemplary embodiment of the invention; and

FIG. 15 is a flowchart of a synchronous management algorithm of the PC of the third exemplary embodiment of the invention.

### DETAILED DESCRIPTION OF THE EXEMPLARY EMBODIMENTS

The exemplary embodiments of the invention will now be described in detail with reference to the drawings.

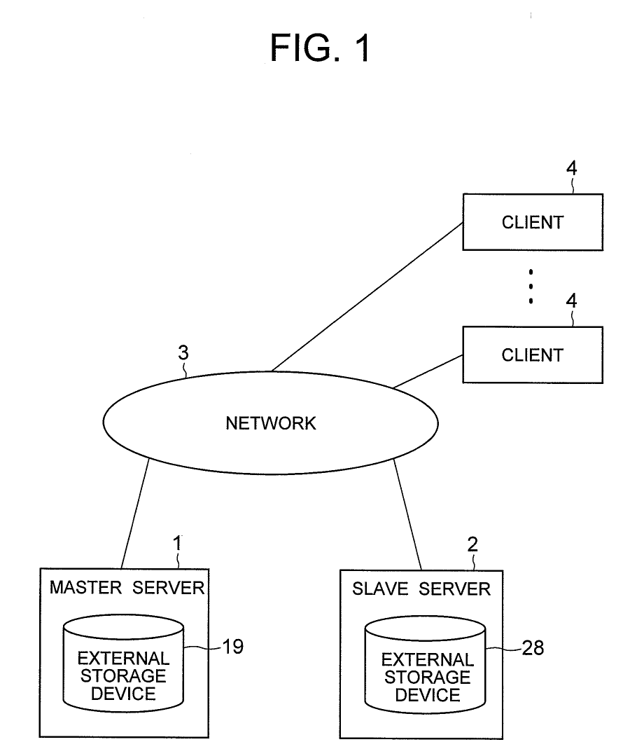

FIG. 1 is an overall configuration view of a distributed file service system according to a first exemplary embodiment of the invention. The first exemplary embodiment includes, as servers for performing a file service, a master server 1 which performs access management of the entire system and a slave server 2 which holds duplicates of the data of the master server 1. The file servers are connected by way of a network 3. The master server 1 and the slave server 2 respectively include an external storage device 19, 29 for storing files.

The first exemplary embodiment includes a plurality of clients 4 which accesses the servers via the network 3. A case in which one master server and one slave server are arranged is shown in FIG. 1, but the master server and the slave server may be arranged in plurals. Furthermore, two clients are shown in FIG. 1, but may be three or more.

The client 4 is an information processing device such as a personal computer (hereinafter written as “PC”) that has a function of connecting to the network 3, and a function of a client to use the file sharing service provided by the master server 1 and the slave server 2. Each client 4 requests for input/output of a file to/from the master server 1 or the slave server 2, where in normal use, load distribution is achieved by arranging the slave server 2 in plurals. In such a case, the client 4 selects one of the plural slave servers 2, and then accesses the file on the relevant slave server 2. An IP (Internet Protocol) address resolution through a DNS (Domain Name System) server used on the Internet, for example, can be applied as a measure for the client 4 to select the slave server. Specifically, load distribution is achieved by including the DNS server, which has received the inquiry, return the IP address of the slave server 2 that is physically close to the client 4.

The method of realizing the network 3 is not limited herein. In addition to the IP base network used on the Internet, the present invention may apply to an SAN (Storage Area Network) environment etc. using a fiber channel and the like is also possible. In such a case, in addition to the network 3 on the client 4 side, networks are inserted between the master server 1 and the slave server 2, and the external storage devices 19, 28, respectively. The external storage device is shared by each server. The present invention may also apply even when it is configured with a network dedicated to an independent external storage device. That is, the external storage devices 19, 28 are not limited to the ones being incorporated in the master server 1 or the slave server 2.

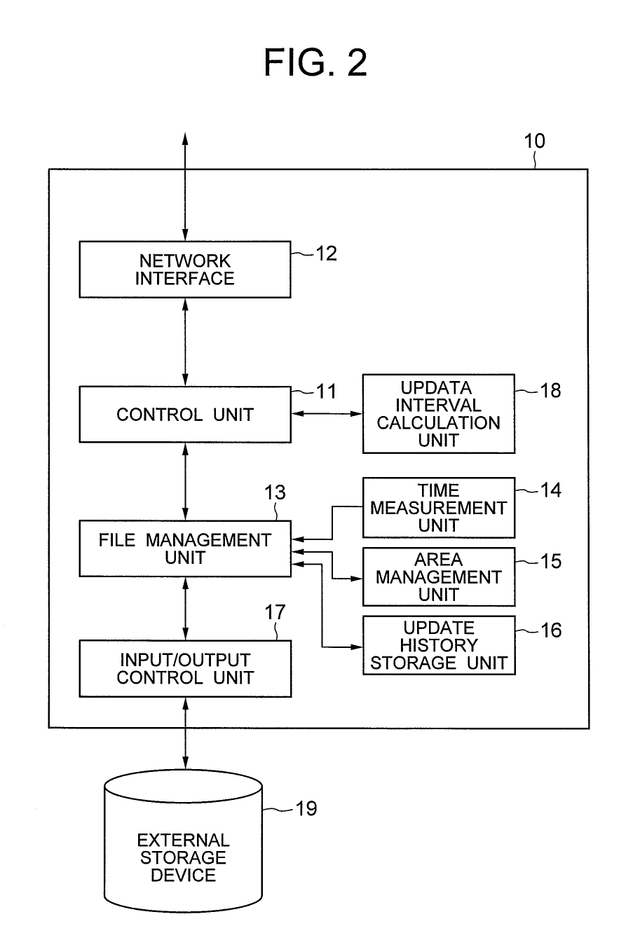

The configuration of the master server 1 will now be described using FIG. 2. The master server 1 includes a master controller 10 for managing the entire file input/output control and the external storage device 19 for storing files. The master controller 10 includes a control unit 11, a network interface 12, a file management unit 13, a time measurement unit 14, an area management unit 15, an update history storage unit 16, an input/output control unit 17, and an update interval calculation unit 18.

The network interface 12 transmits and receives files and commands with the slave server 2 and the client 4.

The control unit 11 executes a process corresponding to the command the network interface 12 received from the slave server 2 or the client 4. Specifically, the control unit 11 interprets the command content of the input/output request received via the network interface 12. The control unit 11 then determines necessity of input/output of data according to the requested content, and sends a file input/output request to the file management unit 13 when determined that input/output of the actual data is necessary. The control unit 11 controls the update interval calculation unit 18 including a function of calculating the update interval of the file based on input/output history information of the file acquired from the file management unit 13. The control unit 11 records the update interval in the external storage device 19 via the file management unit 13, and sends the same to the slave server 2 in response to an information request from the network interface 12.

When the file input/output request is made from the client 4, the time measurement unit 14 records an update history indicating the relevant time.

The area management unit 15 manages the storage area of the external storage device 19.

The file management unit 13 performs arrangement management of the data on a disc. Specifically, the file management unit 13 calculates the recorded position etc. of the actual data using the area management unit 15. The time when the input/output request is made is also measured in the time measurement unit 14, and a history of input/output request for every file is created. The file management unit 13 records the created history in the update history storage unit 16, or records the created history as an update history list in the external storage device 19.

The input/output control unit 17 executes input/output of data with respect to the external storage device 19 based on instruction of the file management unit 13.

The update interval calculation unit 18 calculates, for every file, the update interval of a file and a period (hereinafter referred to as “blank period”) during which it can be assumed that write has not been made with respect to a certain file based on the history. The history on the files stored in the external storage device 28 of the slave server 2 is received from the slave server 2 via the network 3.

The external storage device 19 performs read and write of information with respect to a storage medium. A magnetic disc device, an optical disc device, a silicon disc device, and the like can be used as the external storage device. In the present invention, a case in which one part of a main storage device arranged in the master server 1 etc. is virtually used as the external storage device (e.g. RAM disc) is also encompassed within the concept of external storage device.

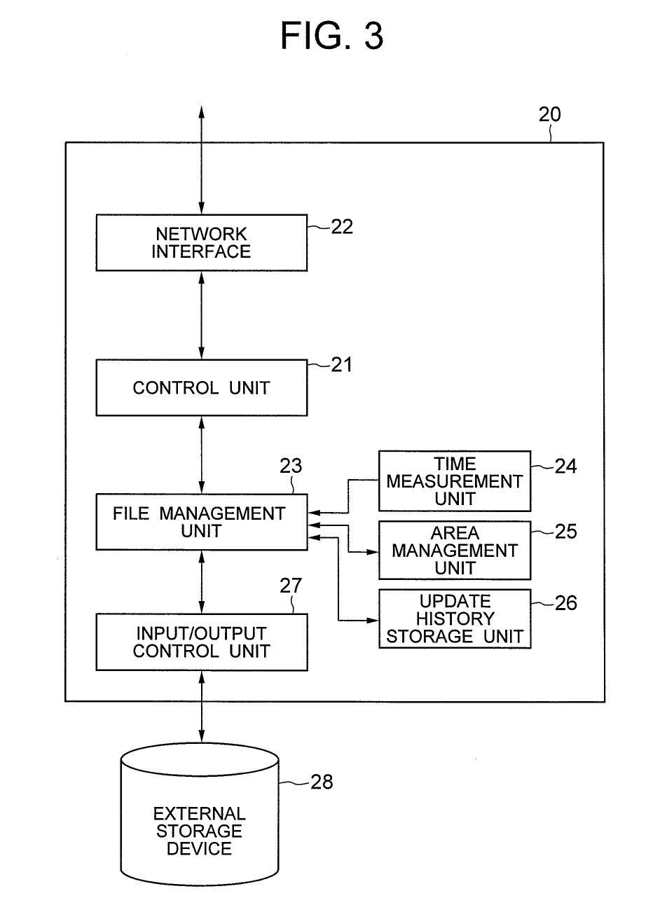

The configuration of the slave server 2 will now be described using FIG. 3. The configuration of the slave server 2 is substantially the same as the configuration of the slave server 1, but differs in that a slave controller 20 does not include the update interval calculation unit.

The network interface 22 transmits and receives files and commands with the master server 1 and the client 4.

The control unit 21 executes a process corresponding to the command the network interface 22 received from the master server 1 or the client 4. Specifically, the control unit 21 interprets the command content of the input/output request received via the network interface 22. The control unit 21 then determines necessity of input/output of data according to the requested content, and sends a file input/output request to the file management unit 23 when determined that input/output of the actual data is necessary. The control unit 21 acquires the update interval and the update time from the master server 1 via the network interface 22.

The time measurement unit 24 records the time when the file input/output request is made from the client 4. The area management unit 25 manages the usage state of the area of the external storage device 19.

The file management unit 23 performs arrangement management of data on a disc. Specifically, the file management unit 23 calculates the recorded position etc. of the actual data using the area management unit 25. The time when the input/output request is made is also measured in the time measurement unit 24, and a history of input/output request for every file is created. The file management unit 23 records the created history in the update history storage unit 26, or records the created history as an update history list in the external storage device 28. The input/output control unit 27 executes input/output of data with respect to the external storage device 28 based on instruction of the file management unit 23.

The file input/output operation in the present exemplary embodiment will be described using FIGS. 1 to 8. First, the file input/output operation of the file server based on the request of the client 4 will be described using FIGS. 1 to 3. The update of data and synchronization operation involved in writing to the file will be described, but operations such as moving of the file involving rewriting of the directory are also assumed as writing to the file since update of management metadata etc. is involved.

The client 4 specifies a file on the distributed file management system connected to the network 3 and issues an input/output request. As the method of specifying the file, making an access based on identification information such as URL (Uniform Resource Locator) on the normal Internet is considered, but is not particularly limited to a specific form as long as the file can be specified. If a plurality of servers exists as in the present system, the identification information such as URL is provided by being converted to identification information of one specific server according to an appropriate rule when being converted to server identification information (hereinafter referred to as “host ID”) such as IP address of the host.

The client 4 selects the slave server 2 based on the identification information of the server, and issues the input/output request. Here, it is assumed that the slave server 2 is usually prepared in plurals to distribute the load, the host ID of the slave server 2 is notified to the client 4 and the client 4 issues the input/output request to the relevant slave server 2.

After performing authentication regarding the necessity of access based on the user identification information (hereinafter referred to as “user ID”) or client identification information (hereinafter referred to as “client ID”) obtained from the client 4 via the network interface 22, the slave server 2 accepts the input/output request from the client 4. The input/output request from the client 4 is a request for input/output such as Read/Write in units of files.

The operation of the slave server 2 will now be described. In the slave server 2, the input/output request from the client 4 is received by the network interface 22, and such command is transmitted to the control unit 21. The control unit 21 performs synchronous management of the file according to the command content, and thereafter, executes input/output of the file on a local disc. The synchronous management algorithm of the file will be hereinafter described. In the control unit 21, the instruction of input/output of the file stored in the local disc is provided to the file management unit 23, and the input/output of data at the file position on the external storage device 28 is executed through the input/output control unit 27.

In the input/output operation, the update history information is generated including the time information measured in the time measurement unit 24 and the user ID or the client ID information for specifying the request issuing source of the client 4 in the file management unit 23, and managed in the update history storage unit 26 to leave the history of the requested content. The file management unit 23 records the history data in the external storage device 28 or the update history storage unit 26 as metadata information of the file management system along with an area management structure of the external storage device used by the file management system. The metadata of the file management system refers to a data structure that carries out area management of the files managed by the file management system.

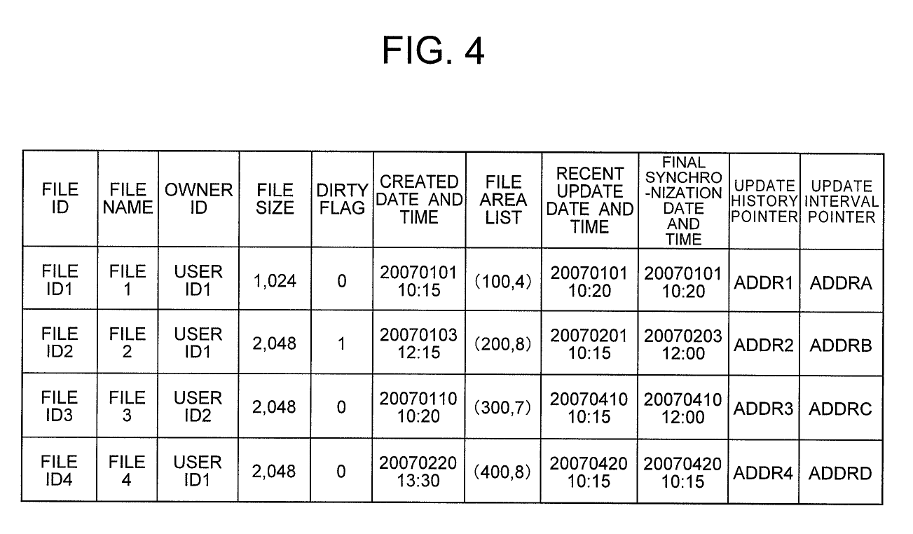

FIG. 4 shows one example of a data structure of the file management metadata information.

“File ID” is information for the file management system to identify the file. “File name” is information for the user to identify the file. “Owner ID” is information indicating the user ID of the owner of the file. “File size” is information indicating the data amount of the file in units of bytes. “Dirty flag” is information indicating whether or not the relevant file is synchronized, where value “0” indicates being synchronized and value “1” indicates not being synchronized (Dirty). “Created date and time” is information indicating the date and the time the file is created. “File area list” is information indicating the storage area at where the file is stored on the external storage device 28. “Recent update date and time” is information indicating the recent date and the time the update is performed on the relevant file. “Final synchronization date and time” is information indicating the most recent date and the time the synchronization is performed on the relevant file. Each item described up to now is generally to be used in the file system, and not all of such items need to be included in the metadata in the implementation of the present invention. Further, it is also acceptable that items other than the above are included.

An update history pointer is information pointing to a position at where the update history on the relevant file is stored. The value of “Addrl” and the like indicates the address of the memory, the block or the sector of the external storage device, or the like.

An update interval pointer is information pointing to a position at where the update interval on the relevant file is stored. The value of “AddrA” and the like indicates the address of the memory, the block or the sector of the external storage device, or the like.

The update history is to be sequentially added and becomes larger, but the size thereof merely needs to be held within a period necessary in processing of the update interval in the update interval calculation unit 18 in the master server 1. If the analysis of the data access cycle is set to a maximum of one week in the update interval calculation unit 18, the update history merely needs to be held within the relevant period. After the calculation process in the update interval calculation unit 18, implementation of appropriately deleting the update history and suppressing enlargement may be applied.

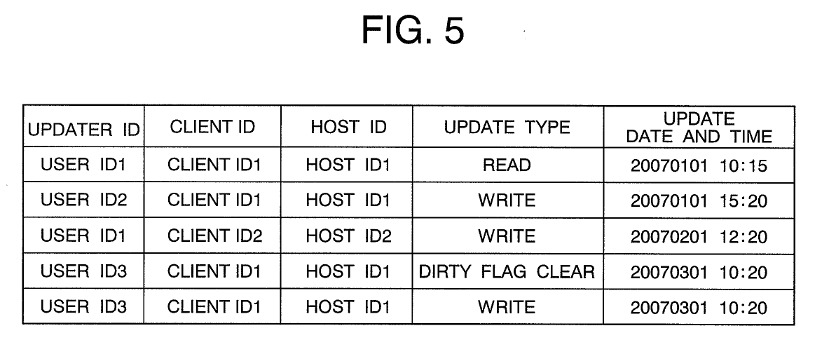

The file management unit 13 lists the update history as an access history as shown in an example of FIG. 5 for every file, and records the same on the external storage device 19. “Updater ID” is a user ID of the user who made the update request of the file. “Client ID” is a client ID of the client 4 which transmitted the request. “Host ID” is a server ID of the host server 1 or the slave server 2 which executed the update process of the file according to the request. “Update type” is information indicating the type of request, where “Read” indicates a readout request, “Write” indicates a write request, and “Dirty Flag clear” indicates a request to set the “Dirty flag” of FIG. 4 to be “0”. “Update date and time” indicates the date and the time the update is executed.

The update history information is used in synchronous management in the file management system, and thus needs to be managed in a unified manner by the file management mechanism to guarantee consistency. Thus, data complying with the metadata such as update interval information obtained from the history management and the history thereof are also uniquely managed by the file management system. In the present exemplary embodiment, the update history information is uniquely readout using the update history pointer and the update interval pointer from the metadata managing the file as shown in FIG. 4.

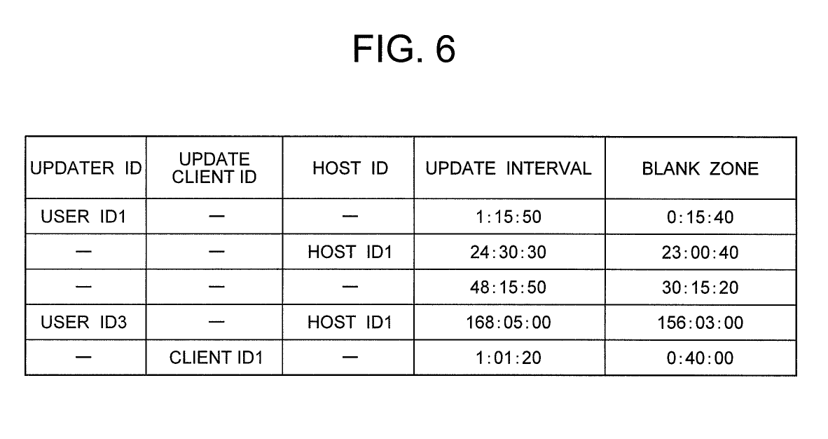

In the present exemplary embodiment, the properties of update on the file are managed as an update interval list as shown in FIG. 6 for every file based on the update interval calculation. This can also be referenced as the update interval pointer from the metadata of the file management system, as described above. “Updater ID”, “Update client ID”, “Host ID” are as described in FIG. 5. “Update interval” is information indicating the length of time between update executions. “Blank period” is information indicating the length of period in which update is not executed or is assumed to have not been executed. In this example, such periods are indicated in units of “time (h)”.

Other than the file management structure shown in FIG. 4, the metadata of the file management system can be realized in the file management system on a general purpose OS (Operating System) such as Windows (registered trademark), Linux (registered trademark) and the like by introducing mechanisms similar to the update history pointer and the update interval pointer if attributes can be extended.

The update interval calculation unit 18 of the master server 1 makes an analysis on the update interval based on the access history on each slave server 2, and generates the resultant information as an update interval list shown in FIG. 6. The algorithm for generating the update interval list of the update interval calculation unit 18 will be hereinafter described.

In the master server 1, the update history list of the master server 1 can be corrected based on the history information in the slave server 2 by transmitting and receiving the metadata information of the file management system further including the update interval list and the update history list via the network interface 12. Consequently, with regards to the accesses made on the external storage device of the plurality of slave servers 2, the update history can be collected, and the properties thereof can be analyzed in the update interval calculation unit 18.

The update history list and the update interval list are recorded on a disc in the master server 1 and the slave server 2 as data referenced from the metadata of the file management system, as described above. The consistency of the data is ensured by once tallying the information measured in the slave server 2 in the master server 1 and distributing the calculation result to the slave server 2.

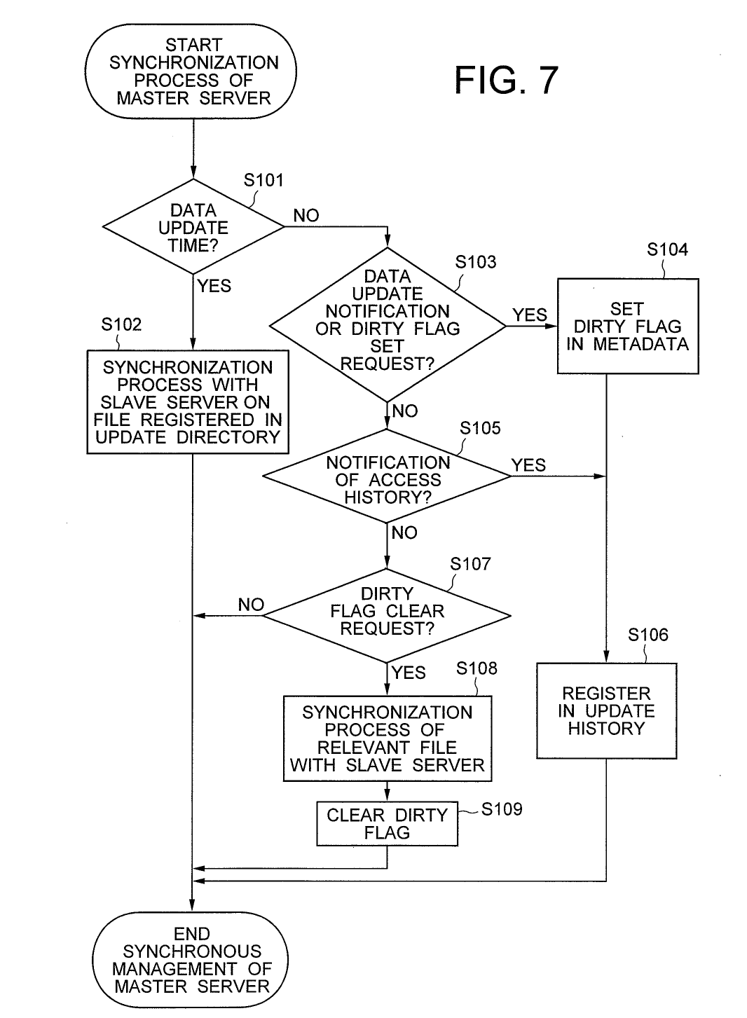

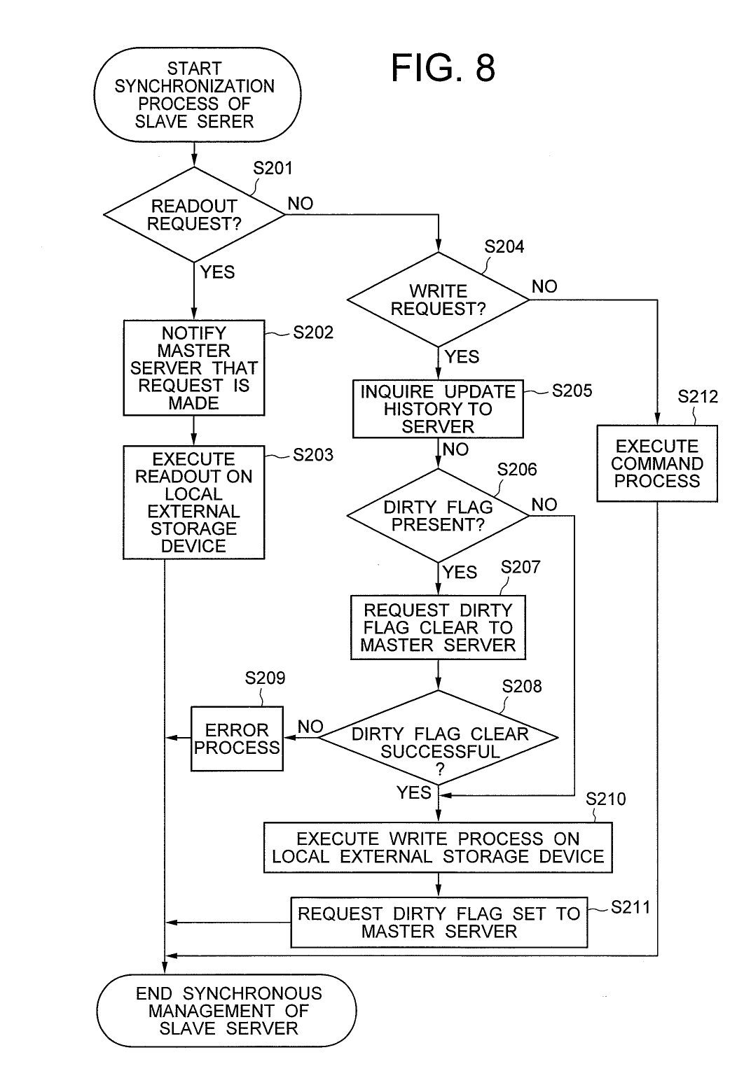

The synchronization between the master server 1 and the slave server 2 using the update interval list will now be described using FIGS. 7 and 8. Various methods can be considered for synchronization. A representative method includes a method in which the master server 1 manages the timing of synchronization, determines the file to be synchronized, and performs the synchronization operation. A method in which the slave server 2 manages and determines the file to be synchronized and performs the synchronization operation may also be adopted. The method in which the master server 1 manages the synchronization timing will be described below.

First, a flowchart of file input/output including synchronous management of the master server 1 is shown in FIG. 7. The master server 1 performs exchange files and metadata with the slave server 2 based on the flowchart of synchronous management and also performs file management flag control in time of various event occurrences. Normally, in addition to executions at a periodic time interval, various command notifications from the slave server 2 are handled as events, and the processes based on the flowchart are performed every time.

First, the type of event is determined, and whether the event is the one based on time interval is determined (S101). If it is the event at the data update time, mutual copying is executed with the slave server 2 regarding the file registered in the update directory as the data to be updated, and synchronization of data is executed (S102, YES in determination of S101). With respect to the event based on the time interval, the data to be updated is registered and managed in the update directory organized according to update time to manage the timing at which each file is to be updated based on the update interval list, and the synchronization operation is executed sequentially at the time of update time event. The update directory will be hereinafter described in detail.

If the event is the one based on a command, and which is other than the update time event (NO in determination of S101), the type of command is sequentially determined. First, whether or not the event is either the data update notification of a specific file or the Dirty flag set request is determined (S103). If the event is either of them, the Dirty flag is set in the metadata (S104), and the command processing content is recorded in the update notification list of the data (S106).

If the event is neither the data update notification nor the Dirty flag set request, whether the event is notification of access history such as reading of data is determined (S105). If so, registration to the update history is only executed (S106). If the event is not the notification of access history, whether the event is the request to clear the Dirty flag of the metadata is determined (S107). If not, the process is terminated, and if so, the synchronization process of the data content is performed with the slave server 2 only on the relevant file (S108), and then the Dirty flag of the metadata is cleared (s109).

A flowchart of file input/output including synchronous management of the slave server 2 is shown in FIG. 8. The slave server 2 performs input/output control of a file according to the flowchart with various input/output requests from the client 4 and the master server 1 as events. First, whether the command is the data readout request command is determined (S201). If the command is the data readout request command, the access history of readout and occurrence of the readout event is notified to the master server (S202). Subsequently, readout is executed on the copied file of the external storage device 28 of the slave server 2 (S203).

When determined that the command is the data write request command (YES in determination of S204), the content of the update flag of the relevant file is inquired to the master server 1 (S205), and the presence of the Dirty flag is checked (S206). If the flag is being set, the request for clear is issued to the master server 1 (S207). If the dirty flag clear in the master server 1 is not successful, error process such as notifying error to the client 4 is performed (S209), but if not, the write request from the client 4 is executed on the file of the local disc (S210), and the setting of the Dirty flag is again requested to the master server 1 (S211). In cases of command processes other than the data readout request and the data write request (NO in determination of S204), the process is executed in accordance with each command (S212), and the file input/output process and the related process are completed.

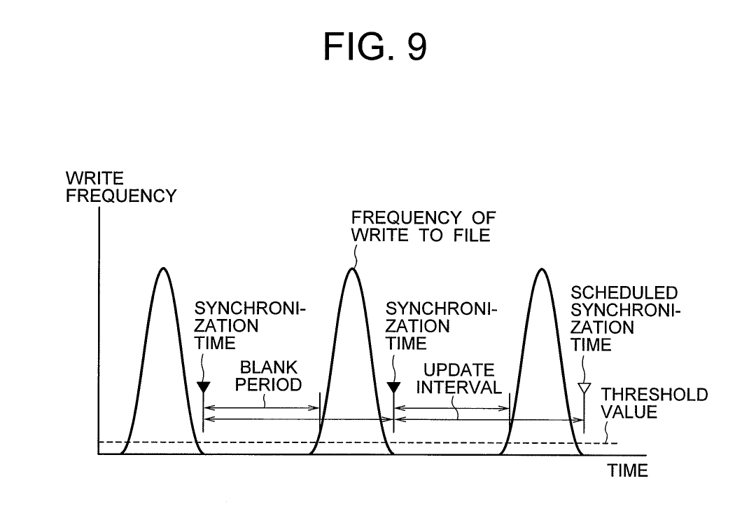

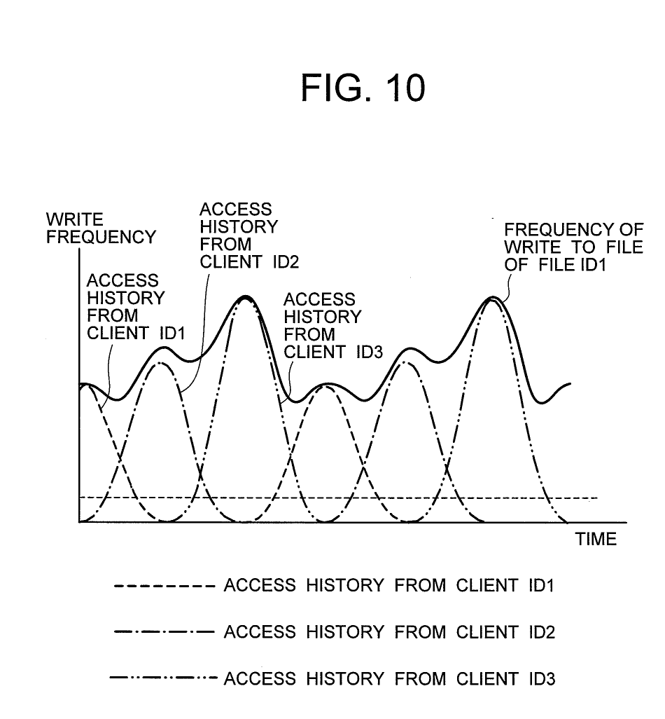

A method of determining the update interval of the update interval calculation unit 18 will be described using FIGS. 9 and 10. The control unit 11 of the master server 1 acquires the update history list for every file from the file management metadata of the external storage device 19 or the update history storage unit 16 through the file management unit 13. This data is sent to the update interval calculation unit 18, and the update interval is determined through the following processing procedures.

First, a simple example is shown in FIG. 9. The frequency of write at a constant time interval is tallied based on the update history, and the graph of time vs frequency is obtained as in FIG. 9. The frequency distribution is tallied/measured based on the write access history. The write frequency is tallied as number of write requests per unit time, for example. Since a zone in which the frequency is high and a zone in which the frequency is substantially zero coexist, a threshold value of an appropriate frequency is set firstly, and then the zone in which write is not made (hereinafter referred to as “blank period”) is measured assuming lower than or equal to such threshold value as zero frequency. The write has a certain periodicity with the blank period in between, and thus the periodicity is assumed as the update interval based on the rewrite frequency distribution in which write is performed two or more times. In this case, update of data is not made for a while after the start time of the blank period, and thus a state in which data is synchronized can be maintained for a period of longer than or equal to half of the processing time by setting the start time of the blank period to the synchronization time and synchronizing the data between the master server 1 and the slave server 2 at the relevant time.

In the case of file access in which update of data occurs periodically, the write frequency distribution of the next period can be estimated from the update interval obtained from the write frequency distributions of a plurality of times, and the synchronization time at the beginning of the blank period. The time after a lapse of the update interval from the synchronization time can be set as the next scheduled time for synchronization.

If the update process of the data is executed based on a determined processing routine, the processing content of the write access is configured by the write process of substantially a constant number of times and sizes. In this case, the time necessary for the individual data update process including a plurality of writes and readouts can be relatively easily estimated. That is, when the rewrite operation is increased, the duration period is estimated as follows based on the update interval and the blank period in the update frequency distribution:

(write duration period)=(update interval)−(blank period)

Thus, based on such period, the access converging time can be estimated at the time of write occurrence. For instance, at the time point when the rewrite access of the data starts to occur in the write frequency distribution, estimation can be made that the write access is to be converged after the above described write duration period, the next execution for synchronization can be scheduled at the relevant time. As a result, the synchronization operation can be effectively executed at the time point the rewrite access is settled.

An update example of the file involving write from a plurality of clients is shown in FIG. 10. In the figure, a case in which write to the file of File ID1 is made from three clients of Client ID1, Client ID2, and Client ID 3 is shown. The write from the Client ID1 is shown with a broken line, the write from the Client ID2 is shown with a chain dashed line, and the write from the Client ID3 is shown with a chain double dashed line. Generally, when write is made from a plurality of clients, the frequency of write on the file constantly becomes greater than or equal to a certain frequency, and appropriate synchronization timing becomes difficult to be set. In this case, it can be simplified by classifying each access history according to whether it is from a specific client or from a specific user, and considering the frequency distribution of write as the combination of the above. In the example of FIG. 10, an example in which write is made from three clients at a time difference is shown, but the frequency distribution of the individual write is the write with a blank period as shown in FIG. 9, and thus the update interval, the blank period, and the synchronization time can be calculated similar to the case of FIG. 9. Even when the updater ID, the client ID, and the host ID are limited, if the blank period and the update interval cannot be calculated, the synchronization time is set according to the average update interval.

The update properties of each file obtained in the update interval calculation unit 18 described above are held in the external storage device 19 in a form of the update interval list shown in FIG. 6. The host ID is the host ID of the slave server 2 which is written from the client 4. The update directory is provided as a data structure that facilitates management of synchronization time in order to effectively utilize such data in the synchronization algorithm.

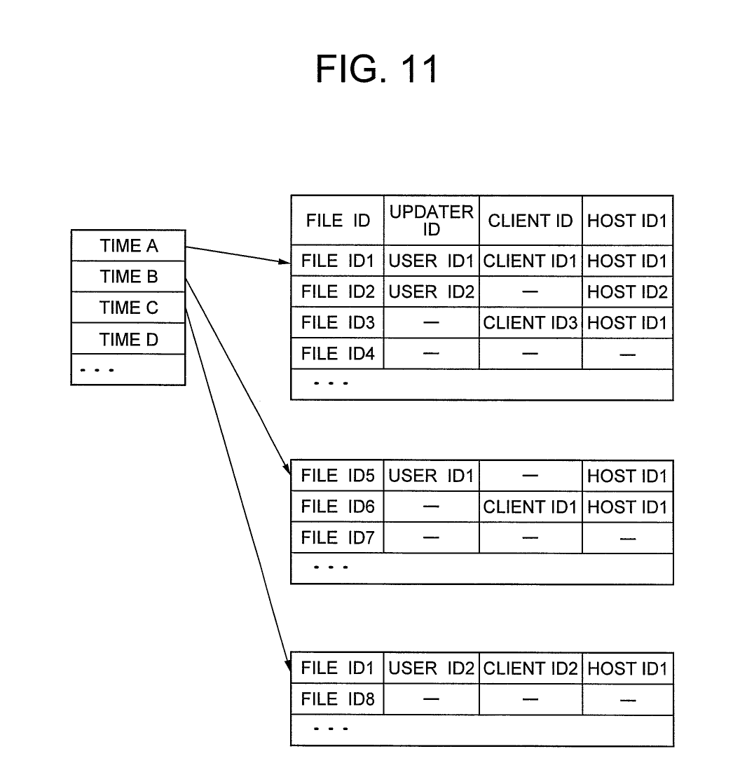

The structure of the update directory will be described using FIG. 11. In the update directory, the synchronization time is determined based on the synchronization time information obtained in the update interval calculation unit 18, and the synchronization content to be performed at the relevant synchronization time is managed as a list. First, the synchronization execution time is obtained, and the corresponding file ID, the updater ID, the client ID, and the host ID, which are the targets of synchronization period, are registered in the time list including the relevant synchronization execution time. Such information are stored as in the update directory of FIG. 11, but such data is managed in the update history storage unit 16 and the like and used as basic information in executing the synchronous management algorithm.

Specifically, the list of FIG. 11 is associated with the time notification from the time measurement units 14, 24, and the synchronization operation is sequentially executed on the target file from time a. The synchronization of each file is executed at the registered time, but the data given the updater ID, the client ID, and the host ID is subjected to the synchronization operation with the slave server 2 of host ID to which the client 4 of the updater ID and the client ID is connected that satisfy the corresponding conditions, where synchronization with another slave server 2 causes execution of the synchronization operation at a timing synchronization is necessary such as when the dirty flag is set, that is, when data write request is made.

The effects of the present exemplary embodiment will be described. If synchronization of data is performed through the network 3 every time the file stored in the storage device 28 of the slave server is updated, the load on the network 3 becomes larger. For instance, data is to be synchronized again even when the relevant file is updated immediately after synchronization is performed, and thus network communication for, in the worst case, the number of updates becomes necessary. Actually, however, it may be sufficient in many cases to update the data after the update of the data is completely finished (see FIG. 9).

According to the present exemplary embodiment, the update interval calculation unit 18 calculates the blank period and the update interval based on the access history on the file, and based on such information, determines the time closest to the beginning of the blank period as the update time while avoiding the period in which update is frequently performed. The file management unit 13 instructs the execution of synchronization at such time to the input/output control unit. Thus, the load on the network 3 in synchronizing the data can be effectively reduced.

In the present exemplary embodiment, the synchronization time is determined based on the update history as described above. The update period calculation unit 18 records the file to be performed with synchronization at each synchronization time in the update directory, and specifies the same. The file management unit 13 references the update directory when receiving notification of arrival of the update time, acquires the file ID of the file to be synchronized, and executes update. That is, the master server 1 does not need to check the update state of the normal directory etc. at a timing synchronization is unnecessary.

Thus, the load and the power consumption on the external storage device 19 can be reduced as a result.

A system for performing management of synchronization based only on the update interval is effective in the web server and the like in which the files are periodically updated. However, it has been difficult to manage the synchronization timing based only on the update interval in accesses in block units in which one part of the file is sequentially updated as in the database file.

In the present exemplary embodiment, the update interval calculation means 18 predicts the zone (blank period) in which access is not made based on the access history, and calculates the synchronization time. Thus, the update timing of the data can be effectively generated even on the file access in which update in block units frequently occur, and a distributed file management of low load in a general file service other than the web service can be realized.

As an exemplary advantage according to the invention, the load on the hardware due to file synchronization can be reduced.

A second exemplary embodiment of the present invention will now be described. The second exemplary relates to a distributed file management system, similar to the first exemplary embodiment. The overall configuration and the configuration of the master server 1 and slave server 2 are respectively the same as shown in FIGS. 1, 2, and 3, and thus the description on such configurations will be omitted.

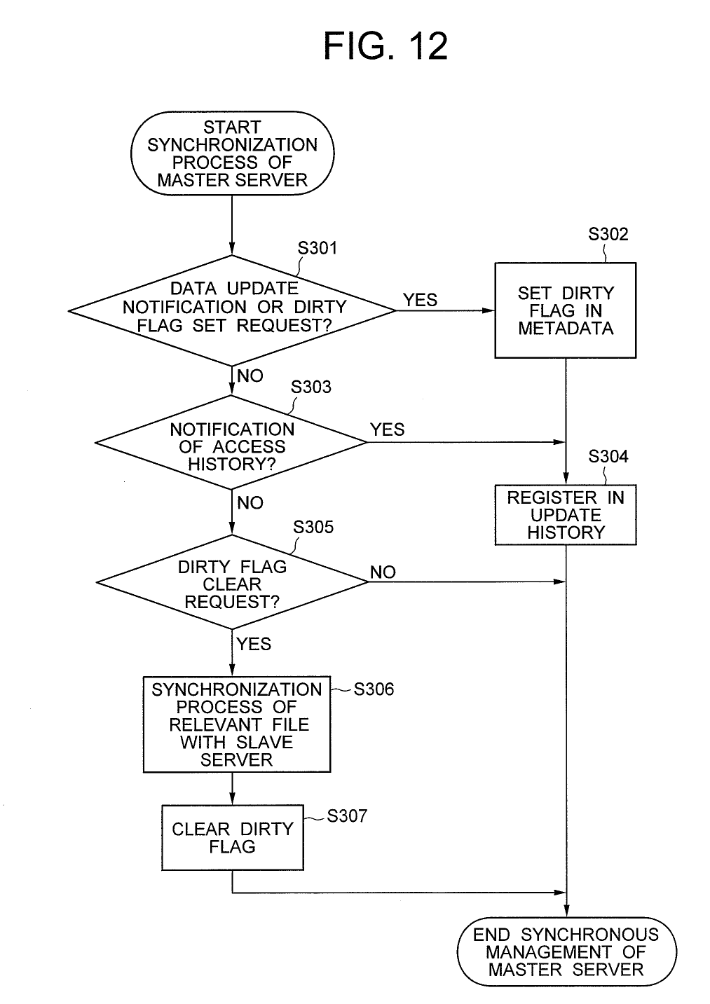

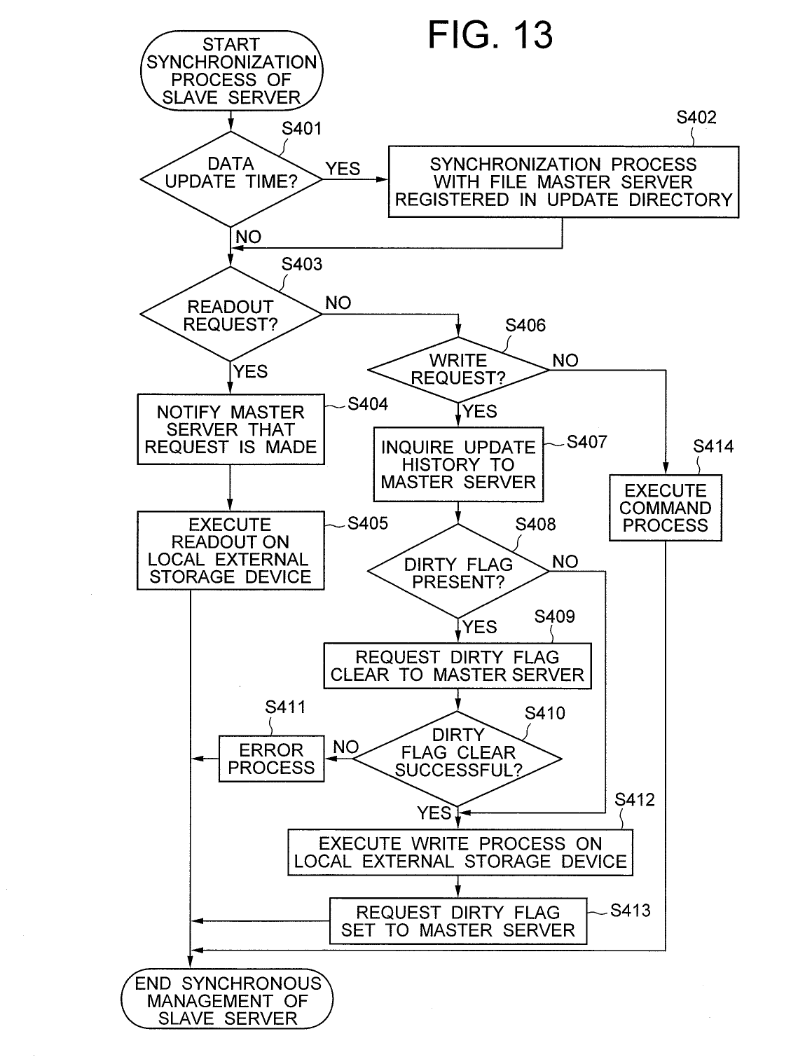

The operation of the second exemplary embodiment will now be described with reference to the flowcharts of FIGS. 12 and 13.

The second exemplary embodiment differs from the first exemplary embodiment in that synchronization of data is executed by the slave server 2.

First, FIG. 12 shows a flowchart of file input/output including synchronous management of the master server 1. Since the master server 1 does not manage the synchronization time in the present exemplary embodiment, it performs exchange of files and metadata with the slave server 2, and performs file management flag control.

Since the event of time does not occur, the process shown in the flowchart of FIG. 12 is executed in time of occurrence of events such as command request to the master server 1.

First, whether the event is the data update notification of a specific file or the Dirty flag set request is determined (S301), where if so, the Dirty flag is set in the metadata (S302), and the command processing content is recorded in the update notification list of the data (S304). In the determination of the command type, whether the event is notification of access history such as reading of data is determined (S303), where if so, registration to the update history is only executed (S304). Similarly, whether the event is the request to clear the Dirty flag of the metadata is determined (S305), where if not, the process is terminated, but if so, the synchronization process of the data content is performed with the slave server 2 only on the relevant file (S306), and then the Dirty flag of the metadata is cleared (S307).

A flowchart of file input/output including synchronous management of the slave server 1 is shown in FIG. 13. The slave server 1 performs input/output control of a file based on the flowchart with various input/output requests from the client 4 and the master server 1, and time notification from the time measurement unit 24 as events.

First, the update directory is acquired from the mater server 1, and determination on the necessity of the synchronization operation is performed based upon the content (S400). Similar to the case of the master server 1 in the first exemplary embodiment, the necessity of synchronization process includes determining whether the process for performing the synchronization operation of each file at the event occurrence time is registered in the update directory, and synchronizing the data with the master server 1 if the process is registered. In this case, execution is made only on the files to which the slave server 2 pertains.

Determination is made on whether the command is a data readout request command (S403), and if the command is the data readout command, the access history of readout and occurrence of the readout event is notified to the master server (S404). Subsequently, readout is executed on the copied files of the external storage device 28 of the slave server 2.

When determined that the command is the data write request command (S406), the content of the update flag of the relevant file is inquired to the master server 1 (S407), and the presence of the Dirty flag is checked (S408). If the flag is set, the request for clear is issued to the master server 1 (S409). If the dirty flag clear in the master server 1 is not successful, error process such as notifying error to the client 4 is performed (S411), but if it is successful, the write request from the client 4 is executed on the file of the local disc (S412), and the setting of the Dirty flag is again requested to the master server 1. In cases of command processes other than the above, the process is executed for each command (S414), and the file input/output process and the related process are completed.

In the second exemplary embodiment, a case of performing file synchronization between the master server 1 and the slave server 2 has been described, but file synchronization may be performed between the master server 1 and the client 4. In this case, the client 4 includes components similar to the network interface 22, the control unit 21, the file management unit 23, the time measurement unit 24, the area management unit 25, the update history storage unit 26, and the external storage device 28 of FIG. 3. However, the files stored in the client 4 do not need to be shared with other clients. Specifically, as such a modification, a replica of a database stored in the master server 1 is stored in the client 4 connected to the master server through wide area network, and the user of the client 4 updates the replica.

Effects similar to the first exemplary embodiment are also obtained with the second exemplary embodiment.

The processing load in the management of the synchronization timing is avoided from concentrating on the master server 1 side by managing the update time on the slave server 2 side, and since such management can be performed on the slave server 2 side, the load can be distributed.

A third exemplary embodiment of the present invention will now be described. In the first and the second exemplary embodiments, file synchronization is performed between two or more devices through the network, but in the third exemplary embodiment, synchronization is performed between two storage media in one device. Assume a case where periodic processing of a file is necessary in a stand alone device such as a PC. In such device, the data on the disc is referenced and the updated data is moved or copied when checking for improper data such as computer virus in the data, or when backing up data in the PC. Here, an exemplary embodiment of taking backups of the file stored in the external storage device connected to the PC in an exchange storage medium will be described.

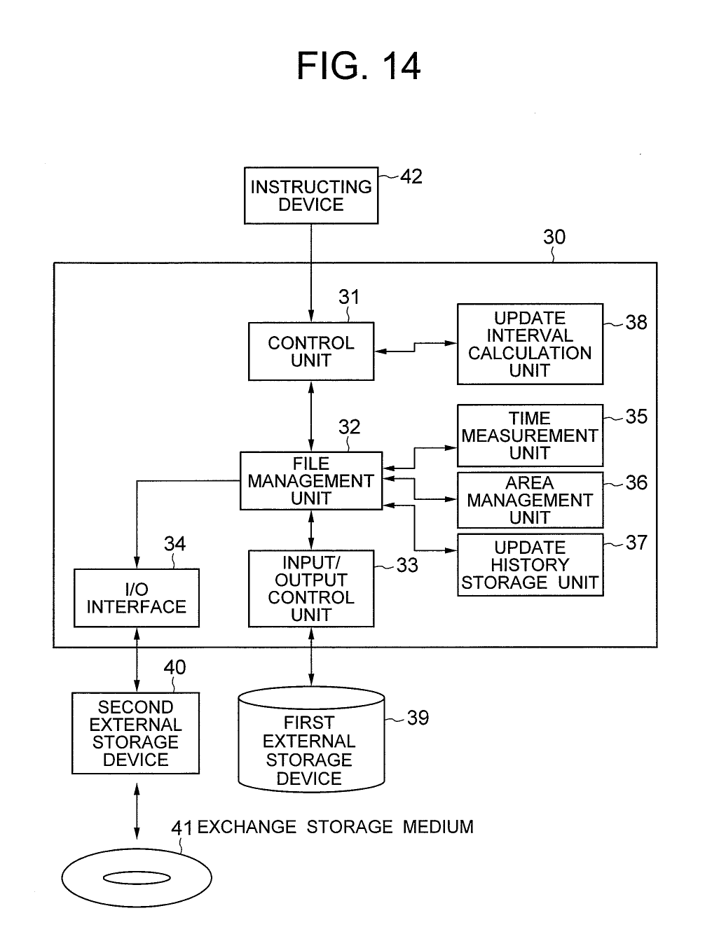

FIG. 14 is a block diagram showing a configuration of a PC of the present exemplary embodiment.

The PC includes a PC controller 30 for managing the entire file input/output control, a first external storage device 39 for storing the file, a second external storage device 40, and an instructing means 42. The PC controller 10 includes a control unit 31, a file management unit 32, an input/output control unit 33, an I/O interface 34, a time measurement unit 35, an area management unit 36, an update history storage unit 37, and an update interval calculation unit 38, and has a function similar to the master controller 10 of FIG. 2.

The control unit 31 executes the process corresponding to the command input by the instructing means 42. Specifically, the control unit 31 interprets the command content of the input/output request made through the instructing means 42. The control unit 31 determines the necessity of input/output of data according to the request content, and makes a file input/output request to the file management unit 32 when determining that the input/output of the data is actually necessary.

The control unit 31 also controls the update interval calculation unit 38 including a function of determining the update interval of the file based on the input/output history information of the file acquired from the file management unit 33. The control unit 31 records the update interval in the external storage device 39 via the file management unit 32.

Furthermore, when making a backup of the data recorded on the first external storage device 39, the control unit 31 determines the necessity of update of the data based on the update directory of FIG. 11, and controls the I/O interface 34 to record the data that needs to be taken backup in the exchange storage medium 40.

When the input/output request of the file is made from the instructing means 42, the time measurement unit 35 records the update history indicating the relevant time.

The area management unit 36 manages the storage area of the first external storage device 39.

The file management unit 32 performs arrangement management of the data of the first external storage device 39. Specifically, the file management unit 32 calculates the recorded position and the like of the actual data using the area management unit 36. Furthermore, the time when the input/output request is made is also measured in the time measurement unit 35, and the history of input/output request for every file is created. The file management unit 32 records the created history in the update history storage unit 37 or records the created history as an update history list in the first external storage device 39.

The input/output control unit 33 executes input/output of data with respect to the first external storage device 39 based on the instruction of the file management unit 32.

The update interval calculation unit 38 calculates the update interval and the blank period of the file for every file stored in the first external storage device 39 based on the history. Similar to the synchronization interval calculation unit 18 of the first embodiment, the synchronization interval calculation unit 38 creates the update directory (see FIG. 11).

The first external storage device 39 is a magnetic disc device for example, and performs read and write of information with respect to the storage medium.

The second external storage device 40 is an optical disc device for example, and performs read and write with respect to the exchange storage medium 41.

The exchange storage medium 41 is a so-called removable media, and is used by being set in the second external storage device 40 when performing input/output of data. CD-RW (Compact Disc-Rewritable), DVD-RW (Digital Versatile Disc-Rewritable), MO (Magneto-Optical Disc), and the like can be used for the exchange storage medium 40.

The instructing means 42 is an input device such as mouse and keyboard, where the user operates the instructing means 42 to give instructions to the PC of the present exemplary embodiment.

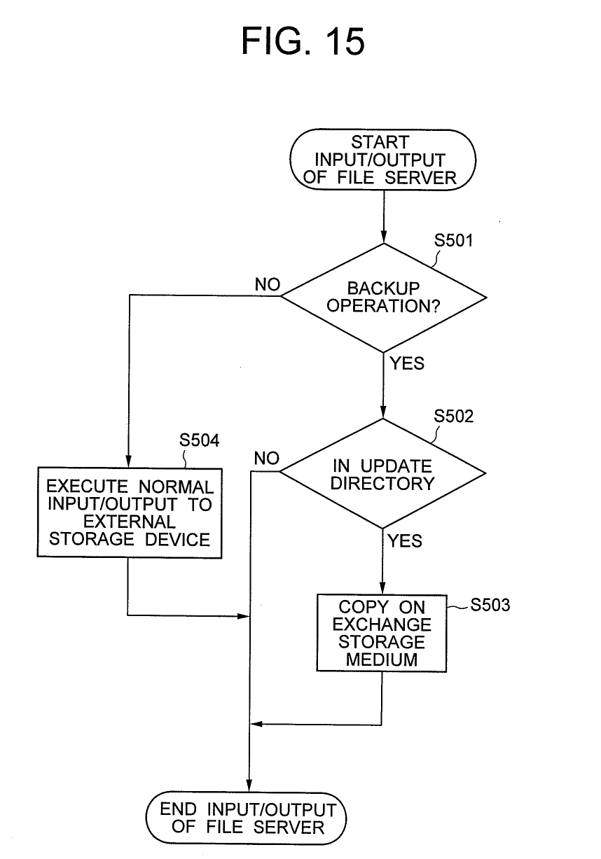

The operation of the present exemplary embodiment will now be described using the flowchart of FIG. 15.

The PC controls input/output of files based on external instruction, but also accepts backup process request. Thus, the input/output operation includes determining whether or not the command is a backup command (S501), and executing a normal file input/output operation if determined as not a backup operation (S504).

In the case of being determined as the backup command, determination is made on whether or not the relevant file is the file registered in the update directory with reference to the update directory (S502). If the file is the registered file, the backup is executed (S503). If the file is not the registered file, no process is executed.

As described above, the wear of the exchange storage medium 41 can be suppressed with limiting the number of writes to the exchange storage medium 41 at a requisite minimum by determining the necessity of backup of the file based on the update directory.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A file management system for performing synchronization process of a file stored in a plurality of storage media, the file management system comprising:
a time measurement unit for recording an update history of the file;
an update interval calculation unit for calculating an update interval and a blank period of the file based on the update history, and determining a synchronization time of the file based on the update interval and the blank period; and
a file management unit for executing synchronization of the file stored in the plurality of storage media at the synchronization time.

2. The file management system according to claim 1, wherein the update interval calculation unit records the update interval and the blank period so as to be corresponded to file management metadata.

3. The file management system according to claim 1, wherein the update interval calculation unit sets a time after a lapse of an update interval contained in the update history from a previous synchronization time as the synchronization time.

4. The file management system according to claim 1, wherein the update interval calculation unit predicts a time when write is to be converged at a time the write to the file starts to occur, and sets the time as a next synchronization time.

5. The file management system according to claim 4, wherein the update interval calculation unit estimates a duration time which is a period from when the write to the file starts to occur until the write is converged, and predicts a time when the write is to be converged based on the duration time.

6. The file management system according to claim 1, wherein
the update interval calculation unit generates, for every synchronization time, an update directory which is a list of files to be synchronized at the relevant time; and
the file management unit executes the synchronization on the files recorded in the update directory at an update time.

7. The file management system according to claim 1, wherein
one master server includes the time measurement unit, the update interval calculation unit, and the file management unit;
one or more slave server, connected to the master server, for managing a duplicate file of a file managed by the master server includes the time measurement unit; and
the update interval calculation unit calculates the update interval and the blank period based on the update history of the duplicate file received from the slave server.

8. The file management system according to claim 1, wherein
one master server includes the time measurement unit, and the update interval calculation unit;
one or more slave server, connected to the master server, for managing a duplicate file of a file managed by the master server includes the time measurement unit and the file management unit;
the update interval calculation unit calculates the update interval and the blank period based on the update history of the duplicate file received from the slave server; and
the file management unit receives the update time from the master server.

9. The file management system according to claim 7, wherein
the time measurement unit records the update history so as to be corresponded to identification information of the slave server which executed the update of the file; and
an update time calculation unit calculates the update time for every slave server.

10. The file management system according to claim 7, wherein
the time measurement unit records the update history so as to be corresponded to identification information of a user who requested the update of the file or identification information of a client who transmitted a command requesting for update of the file; and
an update time calculation unit calculates the update time for every user or for every client.

11. The file management system according to claim 1, wherein at least one of the plurality of storage media is an exchangeable storage medium.

12. A file management system for performing synchronization process of a file stored in a plurality of storage media, the file management system comprising:
a time measurement means for recording an update history of the file;
an update interval calculation means for calculating an update interval and a blank period of the file based on the update history, and determining a synchronization time of the file based on the update interval and the blank period; and
a file management means for executing synchronization of the file stored in the plurality of storage media at the synchronization time.

13. A file management method for performing synchronization process of a file stored in a plurality of storage media, the file management method comprising:
measuring a time in which a time measurement unit records an update history of the file;
calculating an update interval in which an update interval calculation unit calculates an update interval and a blank period of the file based on the update history, and determines a synchronization time of the file based on the update interval and the blank period; and
managing a file in which a file management unit executes synchronization of the file stored in the plurality of storage media at the synchronization time.

14. The file management method according to claim 13, wherein in calculating the update interval, the update interval and the blank period are recorded so as to be corresponded to file management metadata.

15. The file management method according to claim 13, wherein in calculating the update interval, a time after a lapse of an update interval contained in the update history from a previous synchronization time is set as the synchronization time.

16. The file management method according to claim 13, wherein in calculating the update interval, a time when write is to be converged is predicted at a time the write to the file starts to occur, and the time is set as a next synchronization time.

17. The file management method according to claim 16, wherein in calculating the update interval, a duration time which is a period from when the write to the file starts to occur until the write is converged is estimated, and a time when the write is to be converged is predicted based on the duration time.

18. The file management method according to claim 13, wherein
in calculating the update interval, an update directory which is a list of files to be synchronized at the relevant time is generated for every synchronization time; and
in managing a file, the synchronization is executed on the files recorded in the update directory at an update time.

19. The file management method according to claim 13, wherein
one master server includes the time measurement unit, the update interval calculation unit, and the file management unit;
one or more slave server, connected to the master server, for managing a duplicate file of a file managed by the master server includes the time measurement unit; and
in calculating the update interval, the update interval and the blank period are calculated based on the update history of the duplicate file received from the slave server.

20. The file management method according to claim 13, wherein
one master server includes the time measurement unit, and the update interval calculation unit;
one or more slave server, connected to the master server, for managing a duplicate file of a file managed by the master server includes the time measurement unit and the file management unit;
in calculating the update interval, the update interval and the blank period are calculated based on the update history of the duplicate file received from the slave server; and
in managing a file, the update time is received from the master server.

21. The file management method according to claim 19, wherein
in measuring a time, the update history is recorded so as to be corresponded to identification information of the slave server which executed the update of the file; and
in calculating the update interval, the update time is calculated for every slave server.

22. The file management method according to claim 19, wherein
in the time measurement step, the update history is recorded so as to be corresponded to identification information of a user who requested the update of the file or identification information of a client who transmitted a command requesting for update of the file; and
in an update time calculation step, the update time is calculated for every user or for every client.

23. The file management method according to claim 13, wherein at least one of the plurality of storage media is an exchangeable storage medium.

24. A file management program for causing a computer to execute a synchronization process of a file stored in a plurality of storage media, the file management program causing the computer to execute:
a time measurement process of recording an update history of the file;
an update interval calculation process of calculating an update interval and a blank period of the file based on the update history, and determining a synchronization time of the file based on the update interval and the blank period; and
a file management process of executing synchronization of the file stored in the plurality of storage media at the synchronization time.

25. The file management program according to claim 24, wherein in the update interval calculation process, the update interval and the blank period are recorded so as to be corresponded to file management metadata.

26. The file management program according to claim 24, wherein in the update interval calculation process, a time elapsed from a previous synchronization time by an update interval contained in the update history is set as the synchronization time.

27. The file management program according to claim 24, wherein in the update interval calculation process, a time when write is to be converged is predicted at a time the write to the file starts to occur, and the time is set as a next synchronization time.

28. The file management program according to claim 27, wherein in the update interval calculation process, a duration time which is a period from when the write to the file starts to occur until the write is converged is estimated, and a time when the write is to be converged is predicted based on the duration time.

29. The file management program according to claim 24, wherein
in the update interval calculation process, an update directory which is a list of files to be synchronized at the relevant time is generated for every synchronization time; and
in the file management process, the synchronization is executed on the files recorded in the update directory at an update time.
